(19) United States
(12) Patent Application Publication
(10) Pub. No.: US 2023/0118679 A1
(43) Pub. Date: Apr. 20, 2023

(54) Systems And Methods For Categorizing And Visualizing Web Domain Details

(71) Applicant: Bolster, Inc., Los Altos, CA (US)

(72) Inventors: Alain Mayer, San Francisco, CA (US); Abhishek Dubey, Mountain View, CA (US); Shashi Prakash, Los Altos, CA (US); Abhilash Garimella, San Jose, CA (US)

(21) Appl. No.: 17/965,309

(22) Filed: Oct. 13, 2022

Related U.S. Application Data
(60) Provisional application No. 63/256,323, filed on Oct. 15, 2021.

(51) Int. Cl. G06F 16/958; G06F 16/951; H04L 9/40

(52) U.S. Cl. CPC G06F 16/958; G06F 16/951; H04L 63/1441

(57) ABSTRACT

Systems and methods are disclosed for categorizing and visualizing web domain details. In implementations, one or more processors are configured to automatically determine domain variants, using a provided seed domain, based on a level of similarity with the seed domain. The one or more processors may be configured to categorize the domain variants into a plurality of categories. One or more servers may be communicatively coupled with one or more computing devices and may be configured to provide one or more user interfaces for display on the one or more computing devices. The one or more user interfaces may include a visual display of the categories and, for each category, an indicator indicating a total number of the domain variants within that category. Implementations may include training a machine learning module to automatically determine the domain variants and to categorize the domain variants into the plurality of categories.

### CROSS REFERENCE TO RELATED APPLICATIONS

This document claims the benefit of the filing date of U.S. Provisional Pat. Application No. 63/256,323, entitled “Systems And Methods For Categorizing And Visualizing Web Domain Lifecycles,” naming as first inventor Alain Mayer, which was filed on Oct. 15, 2021, the disclosure of which is hereby incorporated entirely herein by reference.

### BACKGROUND

### 1. Technical Field

Aspects of this document relate generally to cybersecurity.

### 2. Background Art

Systems and methods exist in the art to provide cybersecurity protections for computing systems and web domains. However, many cybersecurity threats persist. There exists a need to address ongoing and growing security threats to websites and to users of websites from various attacks including phishing attacks, malicious software attacks, and so forth.

### SUMMARY

Implementations of systems for categorizing and visualizing web domain details may include: one or more processors configured to automatically determine domain variants, using a provided seed domain, based on a level of similarity with the seed domain, the one or more processors further configured to categorize the domain variants into a plurality of categories; and one or more servers communicatively coupled with one or more computing devices and configured to provide one or more user interfaces for display on the one or more computing devices, the one or more user interfaces including: a visual display of the categories; and for each category, an indicator indicating a total number of the domain variants within that category.

Implementations of systems for categorizing and visualizing web domain details may include one or more or all of the following:

The domain variants may be associated with a plurality of top-level domains (TLDs).

The one or more processors may be configured to determine a registration status for each domain variant. The one or more user interfaces may include a visual display of the registration status of at least some of the domain variants.

The one or more processors may be configured to determine, for each of the domain variants, a score related to a potential maliciousness of the domain variant.

If the domain variant is registered, the score may be based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; and a determination of likely deception related to a known brand name.

If the domain variant is unregistered, the score may be based on one or more of: an average domain registration price associated with a top-level domain (TLD); a price for registration of the domain variant; a determined TLD maliciousness; one or more terms in the domain variant determined to be suspicious; and the level of similarity with the seed domain.

The one or more processors may be configured to, based on the score, determine whether the domain variant should be recommended for acquisition and, if so, initiate display of an acquisition recommendation on the one or more user interfaces.

The one or more processors may be further configured to determine, for each of the domain variants which is registered, whether a website associated with the domain variant includes malicious content.

The one or more processors may be further configured to, in response to determining that the website includes malicious content, initiate display of a takedown recommendation on the one or more user interfaces.

The one or more processors may be further configured to monitor content of the website after a takedown and, in response to determining that the website again includes malicious content, initiate display of another takedown recommendation on the one or more user interfaces.

The categories may include at least: a category for unregistered domains recommended for acquisition; a category for registered domains recommended for monitoring; and a category for registered domains recommended for takedown.

The category for registered domains recommended for monitoring may include a plurality of subcategories including at least a category including parked domains.

The visual display of the categories may include, for each category, a displayed container.

Implementations of methods for categorizing and visualizing web domain details may include: using one or more processors: determining domain variants, using a provided seed domain, based on a level of similarity with the seed domain; determining a registration status for each domain variant; categorizing the domain variants into a plurality of categories; and using one or more servers communicatively coupled with one or more computing devices, providing one or more user interfaces for display on the one or more computing devices, the one or more user interfaces including: a visual display of the categories; a visual display of the registration status of at least some of the domain variants; and for each category, an indicator indicating a total number of the domain variants within that category.

Implementations of methods for categorizing and visualizing web domain details may include one or more or all of the following:

The method may include, using the one or more processors, determining, for each of the domain variants, a score related to a potential maliciousness of the domain variant, wherein the score is based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; a determination of likely deception related to a known brand name; an average domain registration price associated with a top-level domain (TLD); a price for registration of the domain variant; a determined TLD maliciousness; one or more terms in the domain variant determined to be suspicious; and the level of similarity with the seed domain.

The categories may include at least: a category for unregistered domains recommended for acquisition; a category for registered domains recommended for monitoring; and a category for registered domains recommended for takedown.

The method may further include, using the one or more processors, determining, for each of the domain variants which is registered, whether a website associated with the domain variant includes malicious content and, in response to determining that the website includes malicious content, initiating display of a takedown recommendation on the one or more user interfaces.

Implementations of systems for categorizing and visualizing web domain details may include: one or more processors; one or more non-transitory computer-readable media storing instructions executable by the one or more processors, wherein the instructions, when executed, cause the system to train one or more machine learning (ML) modules to: automatically determine domain variants, using a provided seed domain, based on a level of similarity with the seed domain; and categorize the domain variants into a plurality of categories, wherein the categories include at least: a category for unregistered domains recommended for acquisition; a category for registered domains recommended for monitoring; and a category for registered domains recommended for takedown; and one or more servers communicatively coupled with one or more computing devices and configured to provide one or more user interfaces for display on the one or more computing devices, the one or more user interfaces comprising: a visual display of the categories; and for each category, an indicator indicating a total number of the domain variants within that category.

Implementations of systems for categorizing and visualizing web domain details may include one or more or all of the following:

The instructions, when executed, may cause the system to train the one or more ML modules to determine, for each of the domain variants, a score related to a potential maliciousness of the domain variant, wherein the score is based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; a determination of likely deception related to a known brand name; an average domain registration price associated with a top-level domain (TLD); a price for registration of the domain variant; a determined TLD maliciousness; one or more terms in the domain variant determined to be suspicious; and the level of similarity with the seed domain.

The instructions, when executed, may cause the system to train the one or more ML modules to determine, for each of the domain variants which is registered, whether a website associated with the domain variant includes malicious content.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a block diagram of a system for categorizing and visualizing web domain details;

FIG. 2 is a block diagram of another system for categorizing and visualizing web domain details, which may be a sub-system of the system of FIG. 1;

FIG. 3 is a flow chart illustrating a sample implementation of a method of categorizing a web domain;

FIG. 4 is user interface implemented using the system of FIG. 1 and/or FIG. 2, the user interface showing a diagram used to visualize various categories of web domains;

FIG. 5 is another user interface implemented using the system of FIG. 1 and/or FIG. 2, the user interface showing a diagram used to visualize various categories of web domains;

FIG. 6 is another user interface implemented using the system of FIG. 1 and/or FIG. 2;

FIG. 7 is another user interface implemented using the system of FIG. 1 and/or FIG. 2;

FIG. 8 is another user interface implemented using the system of FIG. 1 and/or FIG. 2;

FIG. 9 is another user interface implemented using the system of FIG. 1 and/or FIG. 2;

FIG. 10 is another user interface implemented using the system of FIG. 1 and/or FIG. 2;

FIG. 11 is another user interface implemented using the system of FIG. 1 and/or FIG. 2;

FIG. 12 is another user interface implemented using the system of FIG. 1 and/or FIG. 2;

FIG. 13 is another user interface implemented using the system of FIG. 1 and/or FIG. 2;

FIG. 14 is another user interface implemented using the system of FIG. 1 and/or FIG. 2; and

FIG. 15 is another user interface implemented using the system of FIG. 1 and/or FIG. 2.

### DESCRIPTION

Implementations/embodiments disclosed herein (including those not expressly discussed in detail) are not limited to the particular components or procedures described herein. Additional or alternative components, assembly procedures, and/or methods of use consistent with the intended systems and methods for categorizing and visualizing web domain details may be utilized in any implementation. This may include any materials, components, sub-components, methods, sub-methods, steps, and so forth.

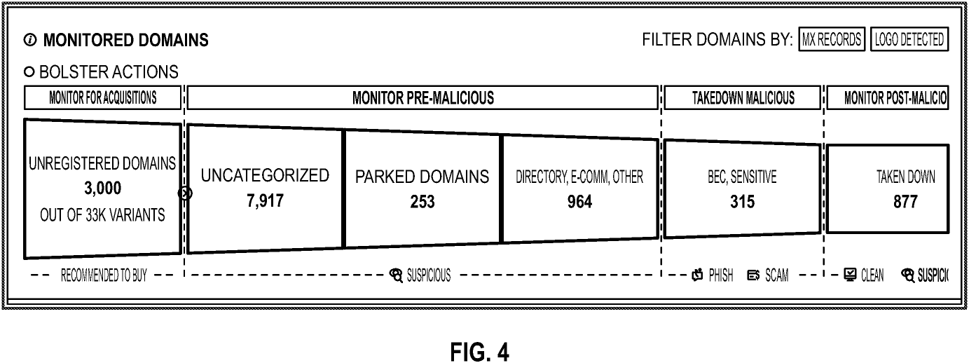

Implementations of systems and methods disclosed herein relate to systems and methods for categorizing and visualizing web domain details, including lifecycles of fraudulent web domains, from before they are registered to after they are taken down. Systems described herein facilitate processes for automatically categorizing complete lifecycles of suspicious and fraudulent web domains at large scale and visualizing them in a diagram that provides both high-level metrics and technical details of the domains. In implementations the system(s) generate a list of several or all possible variants of a given seed web domain, categorizes them based on content and Domain Name Server (DNS) records of the website into lifecycle stages such as “Monitor for Acquisitions,” “Monitor Pre-malicious” and “Post-malicious,” and provides one or more user interfaces for a user to interact with the data using a lifecycle diagram (such as that seen in FIG. 4).

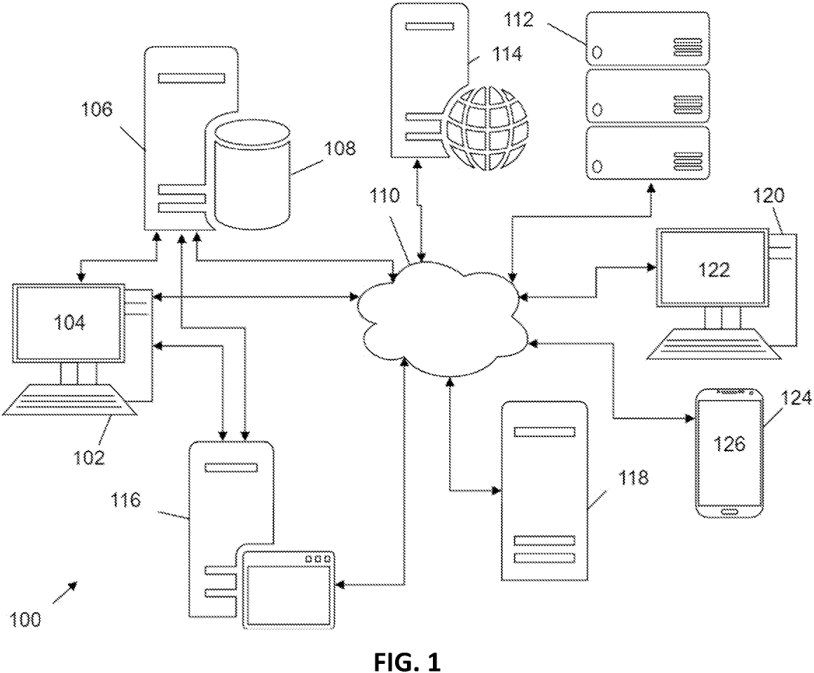

Referring now to FIG. 1, an example system for categorizing and visualizing web domain lifecycles (system) 100 is shown. System 100 includes a computing device (device) 102 with a display 104. Computing device (device) 102 may be used by an administrator to configure various aspects of the system, such as setting up data stores, setting up databases, configuring data stores and/or databases, storing information in data stores or databases, configuring user interfaces, implementing communicative couplings (or access) between computing elements such as various servers and data stores and/or databases, and so forth. Device 102 is communicatively coupled with data store server (server) 106 directly (such as through a local wired or wireless network) and/or indirectly through one or more telecommunications networks (networks) 110 such as, by non-limiting example, the Internet, a local area network (LAN), or any other type of network, any of which may include a variety of routers, computing devices, servers, cell towers, multiple input multiple output (MIMO) towers, and so forth (network 110 in implementations is not a part of system 100, but elements of system 100 may be communicatively coupled through network 110). Data store server 106 is communicatively coupled with a data store 108. In implementations server 106 may be a database server and data store 108 may be a database. In other implementations the data store may not be a database and server 106 may not be a database server.

One or more or all of the aforementioned elements of system 100 may also be communicatively coupled with one or more of the following: web server 114 for providing access to the systems and methods through one or more websites; one or more application servers 116 for allowing the admin or users to access elements and/or services of system 100 through one or more software applications, such as through one or more mobile applications; one or more other servers 118 for processing data and/or executing tasks; and one or more remote server racks 112 (or a portion thereof) for processing data and/or executing tasks (such as, by non-limiting example, AMAZON WEB SERVICES (AWS) servers). One or more end user computing devices, such as computing device (device) 120 (having display 122) and computing device (device) 124 (having display 126), may be communicatively coupled with any other elements of system 100. Device 120 is illustrated as a desktop computer and device 124 is illustrated as a mobile phone, but these are only representative examples. In implementations the computing devices 102, 120, 124 may be any type of device such as, by non-limiting example, a laptop, a personal computer (PC), a desktop computer, a tablet, a personal data assistant (PDA), a smart phone or mobile phone, a smart watch, smart glasses (such as GOOGLE GLASS), a smart speaker, and any other device capable of receiving a user input and providing information in visual and/or audio format.

One of more of the described servers could provide one or more user interfaces for display on one or more of the computing devices, such as by providing data and/or instructions configured to result in the display of the user interfaces on the one or more computing devices.

FIG. 1 is a simplified diagram. System 100 may include any number of any of the devices, servers, server racks, and so forth. Any portion of the system may be scaled up to meet user demand. Additionally, although some of the elements are shown as discrete elements, one or more of the elements may be implemented using a common machine. For example, the administrator device 102 could, through virtualization, include server 106, server 114, and server 116, and so forth. In some implementations the tasks of the individual servers could be carried out by a single machine without the need for virtualization. Any of the elements of system 100 may be excluded in some implementations. Any methods carried out by system 100 may be done in part using containerization, in implementations. The telecommunications network 110 in implementations could be a local area network (LAN) (wired or wireless or hybrid), a wide area network (WAN), or a larger network, or the Internet.

System 100 is only one representative example. In some simplified implementations many or all of the methods of system 100 could be carried out by a single server which includes one or more processors, data storage, one or more executables (code/instructions) stored in data storage or memory of the server for implementing the methods (including providing a website interface, software application and/or mobile application interface, etc.), and so forth. In other implementations multiple or many servers may be used to implement the methods. The system(s) may implement various tasks, including tasks not explicitly disclosed herein but which are inherent to accomplishing the methods and/or end goals described herein.

At any given time there may be any number of end user computing devices 120, 124 (and/or other end user computing devices) communicatively coupled with system 100, to allow for any number of end users. Likewise, there may be any number of administrators and associated administrator devices 102 coupled with system 100.

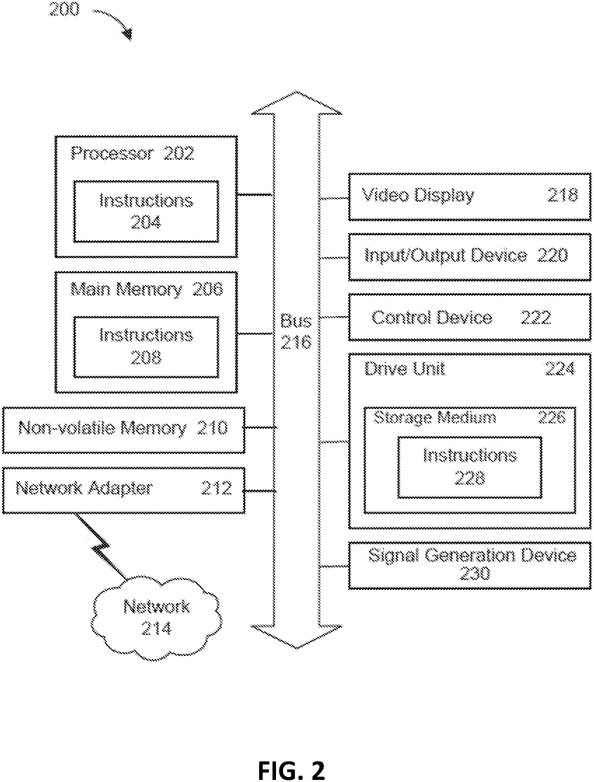

All of the method steps disclosed herein may be performed by one or more processors of one or more computing devices and/or servers of system 100 or 200 (or another system) (system 200 will be described further below). The one or more processors could include any combination of processors of any combination of computing devices/servers of system 100 or 200 or another system. For example, the methods could be implemented using one or more processors of a web server in conjunction with one or more processors of a remote data store server, in conjunction with one or more processors of another remote server, and so forth. The one or more processors could include processor 202 of system 200, shown in FIG. 2, which system 200 may be included in system 100 or communicatively coupled therewith.

Machine learning (ML) and/or artificial intelligence (AI) modules/engines may be included in any of the computing devices/servers of systems 100 or 200 or any other system. Although ML/AI modules/engines themselves are not explicitly shown in the drawings, computing devices and servers such as those shown in systems 100 and 200 are known to be capable of including ML/AI modules/engines, and the general abilities/functionalities of ML/AI modules/engines, and how to generally implement them, are understood by the practitioner of ordinary skill in the art, so that they do not need to be explicitly illustrated in the drawings, other than to say that they may be included in one or more of the computing devices/servers of the systems 100/200, to provide adequate disclosure to enable those skilled in the art to implement and use the systems and methods as claimed. ML/AI modules/engines, for example, could be included in instructions 204, 208 and/or 228 of processing system (system) 200 of FIG. 2, which processing system 200 may be included in system 100 or may be communicatively coupled therewith. The one or more processors may be included in any combination of the one or more computing devices/servers or other elements of system 100. The ML/AI modules/engines may also be included in the one or more computing devices/servers. The one or more processors and ML/AI modules/engines may be communicatively coupled with one another. For example, processor 202 is shown communicatively coupled with instructions 204, 208, 228 in FIG. 2, which instructions may include one or more ML/AI modules/engines.

The ML/AI modules may be trained, using the system, to perform a variety of functions. For example user input, selections, actions and/or feedback could be used to train a machine learning module to: categorize web domains; categorize and/or determine web domain lifecycles; determine variants of a domain name including those similar in sight and/or sound and including/among several or all possible top-level domains (TLDs); score/rank the unregistered variants to determine potential maliciousness and, based on the score/rank, recommend purchase of one or more of the unregistered variants; determine the registered variants which do not yet have malicious content; score/rank the registered variants to determine potential maliciousness; determine the registered variants which already have malicious content or likely malicious content, and recommend takedown thereof; determine suspicious keywords in a domain; determine similarity between a domain in question and a seed domain; determine an intended use related to a domain (such as e-commerce, parked domain, directory, etc.); determine a score for a TLD itself (for example a high score or a low score for TLDs which are more likely to host malicious websites); and so forth. An ML/AI module or engine may further be trained to perform any of the other actions/methods disclosed herein which an ML/AI engine could feasibly perform. Any of the methods disclosed herein may, accordingly, further include training an ML/AI engine/module to perform any tasks or subtasks, and or training it to improve its effectiveness or accuracy in performing such tasks/subtasks.

FIG. 2 is a block diagram illustrating an example of a processing system (system) 200 in which at least some operations described herein can be implemented. For example, one or more of the computing devices and/or servers of system 100 may be implemented as, or may include, example processing system 200. The processing system 200 may include one or more central processing units (“processors”) 202, main memory 206, non-volatile memory 210, network adapter 212 (e.g., network interfaces), video display 218, input/output devices 220, control device 222 (e.g., keyboard and mouse or other pointing devices), drive unit 224 including a storage medium 226, and signal generation device 230, all communicatively coupled with a bus 216. The bus 216 is illustrated as an abstraction that represents any one or more separate physical buses, point to point connections, or both, connected by appropriate bridges, adapters, or controllers. The bus 216, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an INSTITUTE OF ELECTRICAL AND ELECTRONICS ENGINEERS (IEEE) standard 694 bus, also called “FIREWIRE,” and any other bus type.

One or more of the disclosed memories may include non-transitory computer readable media and may include instructions which, when executed, cause the system to train one or more machine learning (ML) modules to perform methods disclosed herein.

In various embodiments, the processing system 200 operates as part of a user device, although the processing system 200 may also be connected (e.g., wired or wirelessly) to the user device. In a networked deployment, the processing system 200 may operate in the capacity of a server or a client machine in a client-server network environment, or as a peer machine in a peer-to-peer (or distributed) network environment.

The processing system 200 may be a server computer, a client computer, a personal computer, a tablet, a laptop computer, a personal digital assistant (PDA), a cellular phone, a processor, a web appliance, a network router, a switch or bridge, a console, a hand-held console, a gaming device, a music player, a network-connected (“smart”) television, a television-connected device, or any portable device or machine capable of executing a set of instructions (sequential or otherwise) that specify actions to be taken by the processing system 200.

While the main memory 206, non-volatile memory 210, and storage medium 226 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 228. The term “machine-readable medium” and “storage medium” shall also be taken to include any medium that is capable of storing, encoding, or carrying a set of instructions for execution by the computing system and that causes the computing system to perform any one or more of the methodologies of the presently disclosed embodiments.

In general, the routines executed to implement the embodiments of the disclosure may be implemented as part of an operating system or a specific application, component, program, object, module or sequence of instructions and may be referred to as one or more “computer programs.” The computer programs typically comprise one or more instructions (e.g., instructions 204, 208, 228) set at various times in various memory and storage devices in a computer, and that, when read and executed by one or more processing units or processors 202, cause the processing system 200 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 210, floppy and other removable disks, hard disk drives, optical disks (e.g., Compact Disk Read-Only Memory (CD ROM, Digital Versatile Disks (DVDs)), and transmission type media, such as digital and analog communication links.

The network adapter 212 enables the processing system 200 to mediate data in a network 214 with an entity that is external to the processing system 200 through any known and/or convenient communications protocol supported by the processing system 200 and the external entity. The network adapter 212 can include one or more of a network adaptor card, a wireless network interface card, a router, an access point, a wireless router, a switch, a multilayer switch, a protocol converter, a gateway, a bridge, a bridge router, a hub, a digital media receiver, a repeater, and any other network adapter type. The network 214 may or may not be part of the system 200, in implementations. In implementations network 214 and network 110 are one and the same, and in other implementations they have some overlap in that at least a portion of one network is also at least a portion of the other network.

The network adapter 212 can include a firewall which can, in some embodiments, govern and/or manage permission to access/proxy data in a computer network and track varying levels of trust between different machines and/or applications. The firewall can include any number of modules having any combination of hardware and/or software components able to enforce a predetermined set of access rights between a particular set of machines and applications, machines and machines, and/or applications and applications, such as to regulate the flow of traffic and resource sharing between these various entities. The firewall may additionally manage and/or have access to an access control list which details permissions including, for example, the access and operation rights of an object by an individual, a machine, and/or an application, and the circumstances under which the permission rights stand (or in other words the circumstances under which the permissions/rights exist).

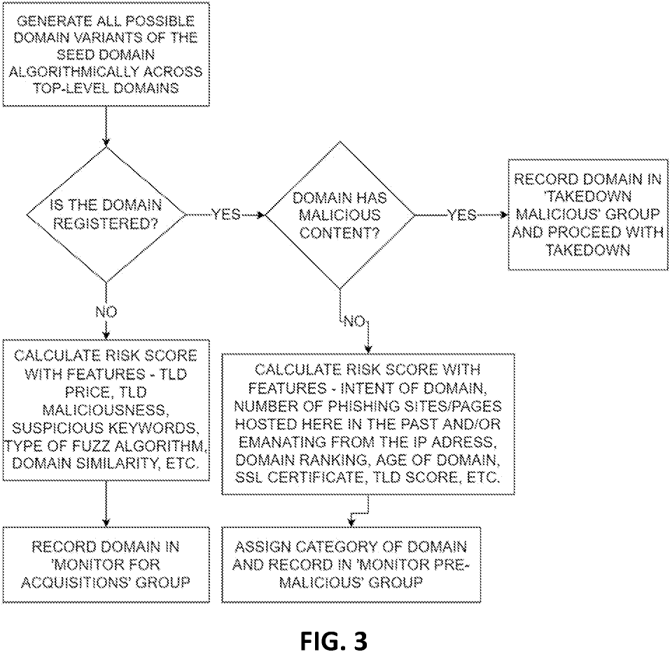

Reference is now made to FIGS. 3-4, which will be used to discuss example methods for categorizing and visualizing web domain lifecycles. When targeting a popular brand or party, threat actors often create web domains that look very similar to a brand’s or party’s original web domain with minor variations. This is done in order prevent users from detecting the online scam. These fraudulent web domains can be used, for example, to send phishing emails and to create phishing and scam websites to defraud users. Threat actors have a wide variety of options to create such fraudulent domains. With over fifteen-hundred Top Level Domains, the number of similar or nearly identical domains that can be made to look like a particular domain can number in the tens of thousands.

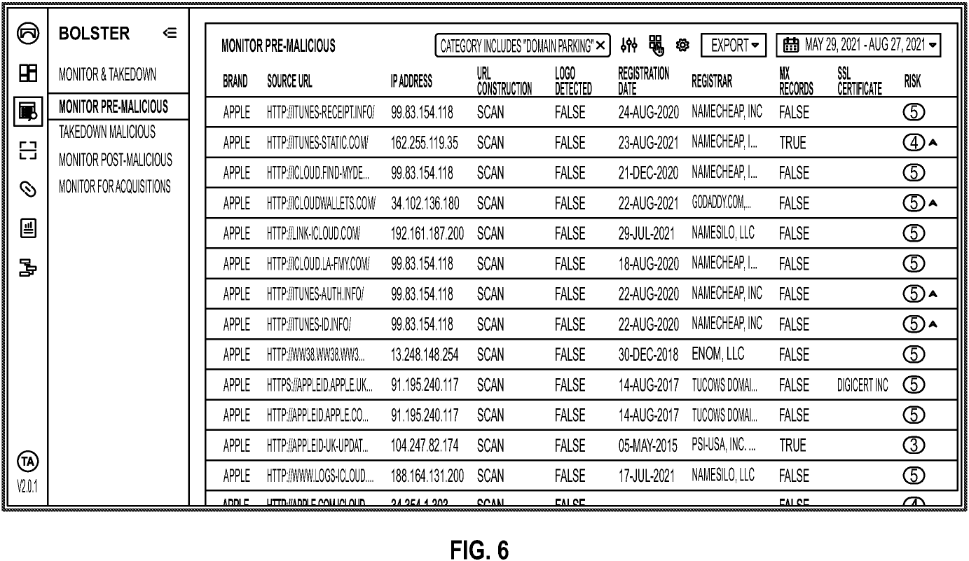

In implementations the system(s) 100/200 perform automated domain categorization in the following four stages:
Stage 1 - The system starts with a seed domain and, using a fuzz algorithm (which is a fuzzy algorithm, but which will be called a fuzz algorithm herein), generates a list of domain variants, determining for example similar-sounding and similar-looking domain names across all possible Top-Level Domains (TLDs). The system ranks all unregistered (and/or registered) domains based on various attributes including TLD price (such as average price of registering a domain with the TLD) or price of registering the actual domain name itself, a determined maliciousness (which could be automatically determined or input by a user), suspicious keywords in the domain (such as determined using a list of known suspicious keywords or using an ML/AI engine), similarity with the seed domain (as determined by the fuzz algorithm and/or by an ML/AI engine), and so forth. A subset of these domains is then recommended for purchase to the user based on ranking—for example all of the unregistered domains above a certain rank or score being recommended for purchase. The scoring/ranking may be to determine a potential risk of the domain being used for malicious purposes. This stage is referred to as “Monitor for Acquisitions” in the lifecycle diagram of FIG. 4. FIG. 4 also shows that the total number of variants may be shown, such as the “out of 33k variants” language. This may reflect the total number of variants that were determined by the fuzz algorithm, but not all of these variants may have been determined to be of interest by the system, some being too dissimilar or unlikely to be useful for malicious attacks, for instance. Thus, while 33k variants were determined, the total number of domains in the various categories of FIG. 4 does not total 33k. In other implementations, the system may categorize every domain that was determined by the fuzz algorithm so that the number of domains in each category adds up to the total number of variants. The domains that are recommended for acquisition may be domains which are at high risk of being used for malicious purposes if they are acquired by others.
Stage 2 - For all the domains which are already registered, a category is determined in real-time using a Machine Learning (ML) or Artificial Intelligence (AI) system/engine. This system/engine can assign categories including “Parked domains,” “Directory Listing,” “E-commerce,” and others. The registered domains are also ranked for risk based on attributes including the aforementioned categories (the category of a domain can also be referred to as its intended use), number of past phishing sites/pages hosted on the domain and/or emanating from the IP address (this can be referred to as previously malicious infrastructure), domain rank obtained from Stage 1, Security Sockets Layer (SSL) certificate details, and a score of the TLD itself (for example a high or low score for TLDs which are more likely to host malicious websites). This ranking/scoring may also take into consideration common malicious techniques for domain names themselves, such as using a domain with a second word and/or with a dash, like http://itunes-id.info to make the domain look like an official ITUNES domain. The system may use all of these attributes to create an overall ranking of the registered domains using one or more algorithms/equations. This second stage is referred to as “Monitor Pre-malicious” in the lifecycle diagram of FIG. 4, with domains grouped into various categories (uncategorized, parked, directory/e-commerce, etc.) and displayed as containers having an isosceles trapezoidal shape, as seen in FIG. 4 (categories other than the “Monitor Pre-malicious” category are also displayed as containers, having a rectangular or isosceles trapezoidal shape—these are only examples and any other shapes are possible for any of the categories). FIG. 4 shows a number or total for each category, including 7,917 uncategorized domains, 253 parked domains, and 964 directory, e-commerce and other domains. In implementations a total number (7,917 + 253 + 964) could also be shown. It is seen that the visual size of each segment is not necessarily represented as larger or smaller relative to the number of domains therein—rather the overall look of FIG. 4 is that of a funnel from left to right, indicating a funneling/filtering process by which different domains of different potential danger/maliciousness are dealt with in different ways. In implementations a user may click on the pre-malicious category/area of FIG. 4 to bring up a ranked list of the pre-malicious domains which ranks them according to risk level. FIG. 6 shows such a list except not ordered by risk level—but the list shows for each variant the seed brand (in this case APPLE), the URL of the variant, the IP address of the hosted site, a URL construction indication, whether a logo (in this case an APPLE logo) was detected on the site, a registration date for the domain, the registrar, an MX records indication (for example indicating whether the site is involved in email exchange), an SSL certificate indication, a risk level (in this case varying from 0 to 5), and an arrow indicating which way the risk level is trending.

URL construction refers to different ways the domains can be constructed: for example adding an extra letter to the end of a domain name (addition) such as WELLSFARGOL.COM, changing one of the valid characters with an invalid character that only changes the binary version by one bit (bit squatting) such as well3argo.com (where the American Standard Code for Information Interchange (ASCII) binary code for 3 and for lowercase s are only off by one bit), exchanging a valid Latin character with an identical or nearly identical non-Latin one (homoglyph) such as WE11SFARGO.COM, swapping a valid vowel with another character (vowel-swap) such as EWLLSFARGO.COM, using a subdomain to appear similar to another domain (subdomain) such as WELL.SFARGO.COM, subtracting a valid character (omission) such as WELLSFARO.COM, replacing a valid character with an invalid one (replacement) such as WELPSFARGO.COM, adding a hyphen (hyphenation) such as WELLS-FARGO.COM, repeating a valid character (repetition) such as WELLSSFARGO.COM, and so forth. These are only examples, and there may be other types of URL construction. If the URL construction states “scan” this means that the URL construction was obtained from a third party source and not by an algorithm or ML module or the like of the system 100. All of the URLs in FIG. 6 list “scan” as the URL Construction, indicating that they were all obtained from third party sources, but in most cases the URL Construction column would list other items such as Addition, Bit Squatting, Homoglyph, Vowel-Swap, Subdomain, Omission, Replacement, Hyphenation, Repetition, etc. In implementations, in addition to generating domain variants, the system may also obtain one or more domain variants (registered or otherwise) from third party sources, for example third party sources listing known malicious sites or sites known to have attempted to impersonate a legitimate site or the like, to include in the monitored domains.

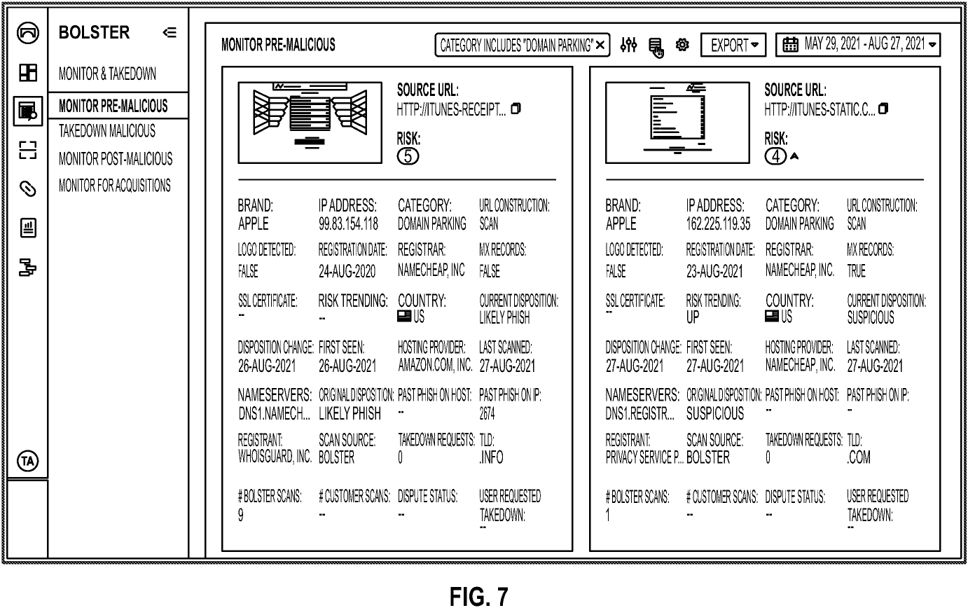

In the example of FIG. 6 only the parked registered domains are shown because the user had clicked on the Parked Domains quadrilateral/area. FIG. 6 is in list view, but the user may select a detailed or stylized view (by clicking on the four-square shape at the top of FIG. 6 over which the cursor is hovering) to bring up a user interface such as that shown in FIG. 7, which shows a small snapshot of the site (which may be clicked on to enlarge the snapshot) and some additional information. The ranked risk level for the registered domains may, in implementations, be used to drop some of the domains from the list entirely (for example if the system and/or ML/AI system/engine determines that some of the domains are registered but are being used, and are likely to continue being used, for legitimate, non-malicious purposes—in such instances these domains may have a very low risk level such as 0 or between 0 and 1 and may be excluded from the pre-malicious list of FIG. 4 entirely.

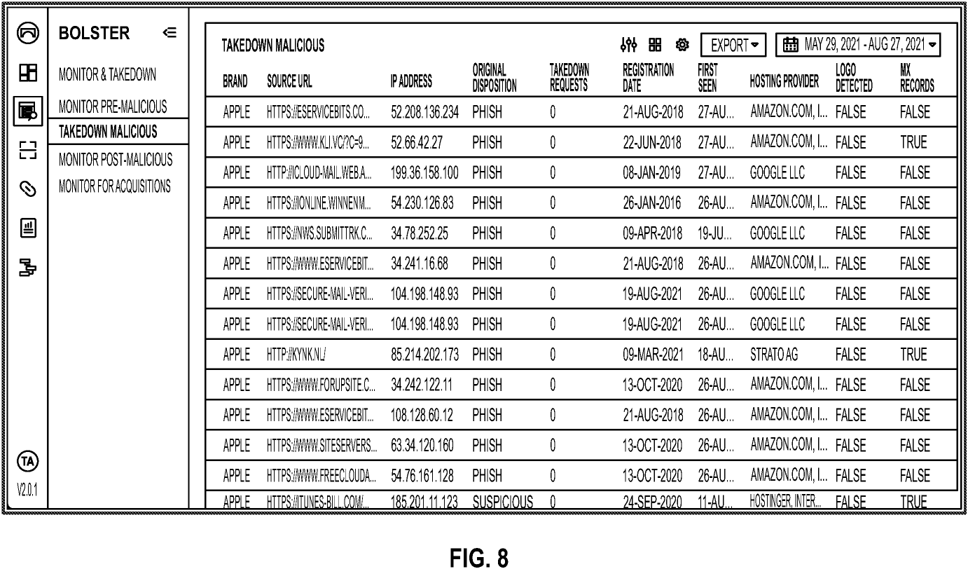

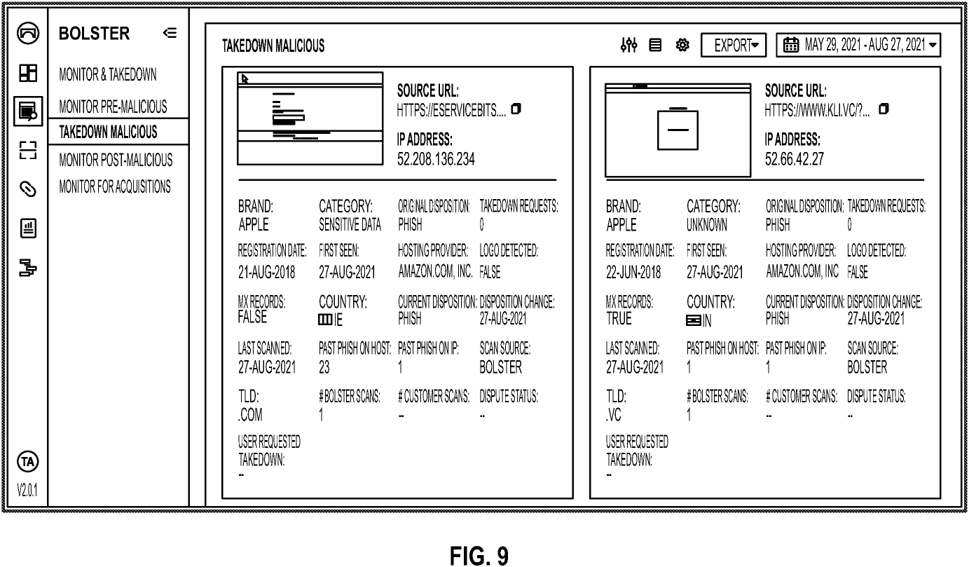

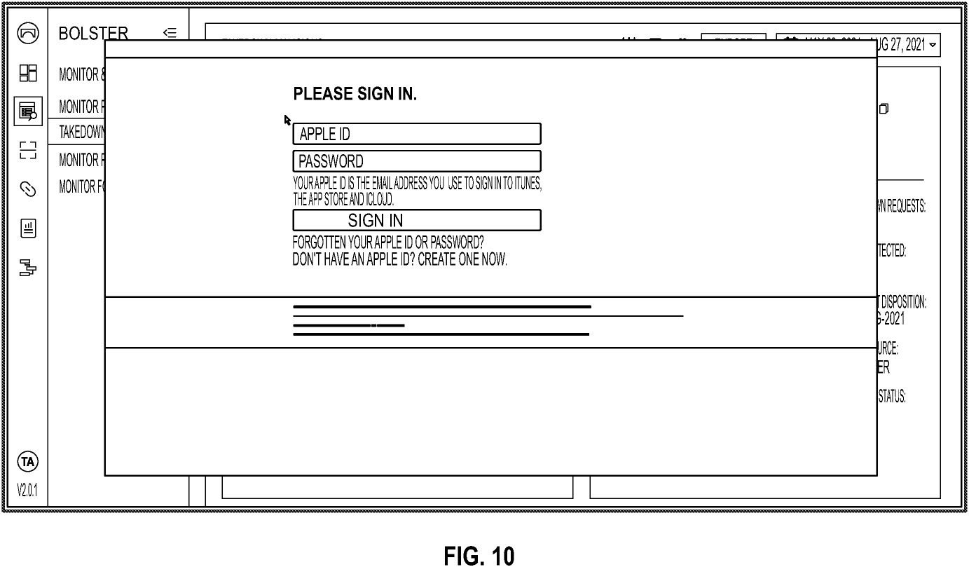

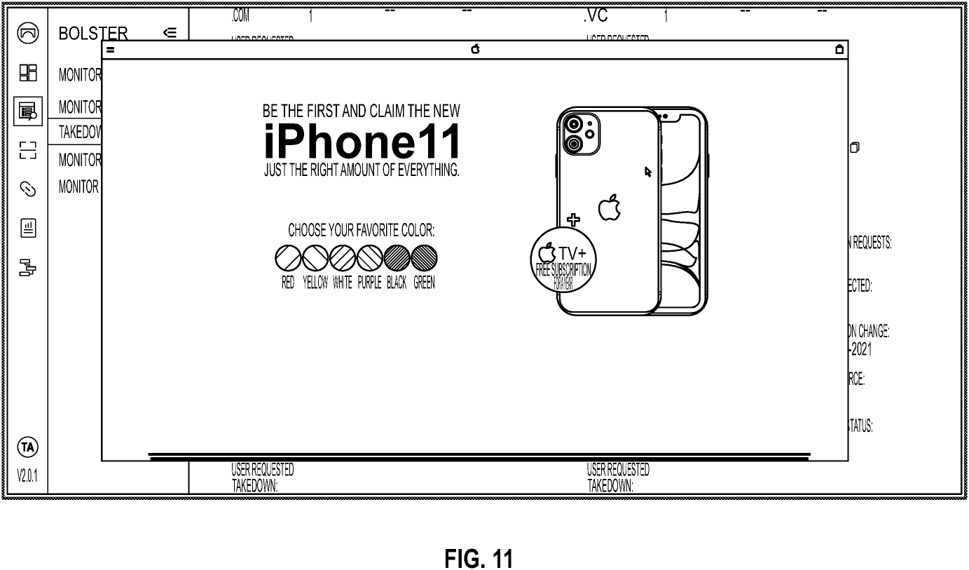

Stage 3 - In this stage the ML/AI system/engine automatically determines which of the registered domains already include (or likely already include) malicious content such as phishing or scam content. The system may determine this by using information from third party sources (such as third party lists of sites with known malicious content) or by using one or more ML modules to determine whether any given domain has, or likely has, malicious content. Such domains are candidates for mitigation such as through takedown notices (to the hosting providers) or automated takedown actions. This stage is referred to as “Takedown Malicious” in the lifecycle diagram of FIG. 4 and can also include determining and/or listing categories of the malicious domains (the examples given are Business Email Compromised or BEC and Sensitive). In FIG. 4 the different categories are lumped together so that there are 315 total malicious domains including BEC and Sensitive domains, but in other implementations the user interface of FIG. 4 could separate the categories out by amount (with or without showing the total added amount), such as 290 BEC domains and 25 Sensitive domains to total 315 malicious domains. If the user selects the “Takedown Malicious” quadrilateral or area of FIG. 4 then a user interface such as FIG. 8 is brought up which shows information similar or analogous to that shown in FIG. 6 for the pre-malicious sites but which includes an original disposition, number of takedown requests, date first seen, and hosting provider. This list may be switched to a detailed/stylized view, similar to pre-malicious list, shown by the user interface of FIG. 9. The small screenshots of FIG. 9 can be clicked on to show an enlarged image, as seen in FIGS. 10 and 11 (the top right snapshot of FIG. 9 does not look exactly like the expanded image of FIG. 11, but the snapshot and FIG. 11 are intended to represent the smaller and larger views, respectively). FIG. 10 shows that the site is clearly a phishing site seeking to obtain a user’s APPLE ID and password, while FIG. 11 shows a site that is masquerading as an official APPLE site—these are examples of sites that have already been weaponized.

Stage 4 - In this domain, any domains that have been successfully taken down are put under continuous monitoring to ensure they don’t start hosting malicious content again. This monitoring is performed automatically by the ML/AI system/engine. This stage is referred to as “Monitor Post-malicious” in the lifecycle diagram of FIG. 4, which also shows the total number of domains which are already taken down and in this category.

FIG. 4 also shows descriptive wording below each category, such as “Recommended to buy” for the “Monitor for Acquisitions” category, “Suspicious” for the “Monitor Pre-Malicious” category, “Phish” and “Scam” for the “Takedown Malicious” category, and “Clean” and “Suspicious” for the “Monitor Post-Malicious” category. In implementations these are only descriptive text, but in other implementations they could be links, such as the “Recommended to buy” text opening an interface showing a list of the domains that are recommended for purchase, the “Suspicious” text (of the “Monitor Pre-Malicious” category) opening a list of the pre-malicious sites organized by type or by some other filter, the “Phish” text opening a list of phishing sites and/or potential phishing sites, the “Scam” text opening a list of scam sites and/or potential scam sites, the “Clean” text opening a list of sites that have been taken down and no longer are malicious, and the “Suspicious” text (of the “Monitor Post-Malicious” category) opening a list of sites that have been taken down but which still (or again) are showing some malicious or potentially malicious content. Any such user interfaces may have functionality for the user to filter or organize the list or data in a variety of ways.

The different category quadrilaterals may also be clicked to open lists such as those given above, in some cases for the different category types. For example the “Uncategorized” quadrilateral may be clicked on to open a list of uncategorized domains, the “Parked Domains” quadrilateral may be clicked on to open a list of parked domains, and so forth. The “Directory, E-Comm, Other” quadrilateral could be clicked on to open a list of these categories separated by headers (such as one continuous list which breaks the domains into categories with list headers such as “Directory,” “E-Commerce,” and so forth), or clicking on this quadrilateral could open an interface which shows another visual graph similar to that of FIG. 4 (or visually different) but showing the different categories, each of which may be clicked on to see its associated list. Any such user interfaces may have functionality for the user to filter or organize the list or data in a variety of ways.

The system may include lists in the datastores or databases of the system(s) 100/200. For example, a list of all determined variants of the seed domain (referenced in the top left box of FIG. 3) may be stored in a datastore of the system 100/200 and/or in a local datastore of a user. This may include datastores for each of the different categories within the list, such as a datastore (or database table, for example) for all domains recommended for purchase, a datastore (or database table) for all pre-malicious domains (and/or a datastore for all uncategorized domains, a datastore for all parked domains, etc.) and so forth. The systems and methods disclosed herein may be termed ranking systems/methods inasmuch as they provide a mechanism by which to rank domains to determine relevant categories.

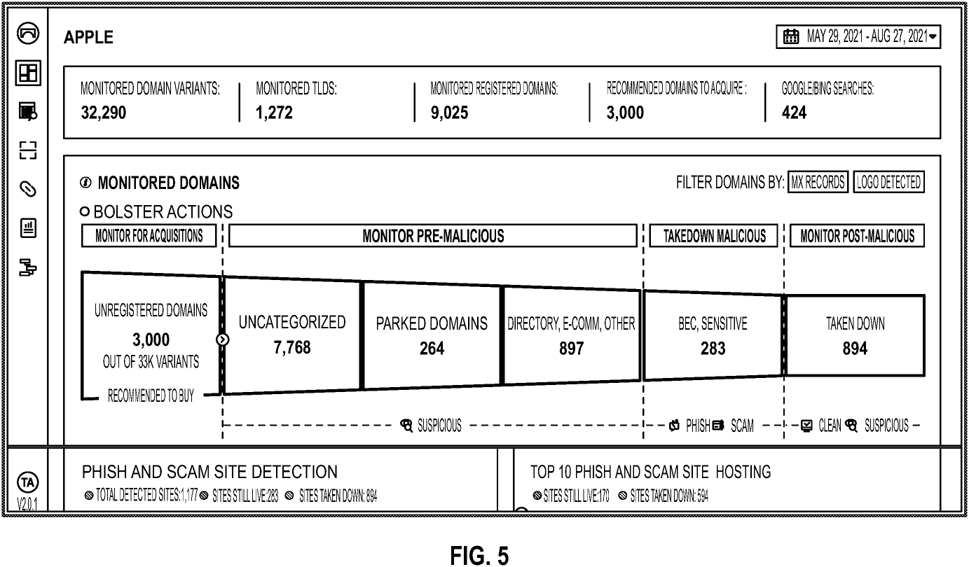

FIG. 5 shows an expanded version of the user interface of FIG. 4 using an example of monitoring domains related to APPLE, just as a non-limiting example. The system may include ongoing monitoring of all the variant domains in all of the lifecycle categories to ensure an accurate present representation—updating the FIG. 5 interface with any new or updated information. The top of the page shows the total number of variants monitored, the total number of TLDs monitored, the total number of registered domains monitored, and the total number of domains recommended for acquisition. As an example, the determined variants may include misspellings such as aple.com, appl.com, words and misspelled words combined with others such as apple-receipts.com, apleiphones.com, and so forth, as well as various other domains similar or related to the seed domain (in this case the seed domain would be APPLE.com). FIG. 5 shows that the user may apply various filters to filter out domains and/or to organize the linked lists based on one or more criteria. For example while FIG. 5 shows that there are 32,290 total domain variants, the total domains on FIG. 5 only adds up to 13,106 (3,000 + 7,768 + 264 + 897 + 283 + 894), and this is because the user has filtered to only see domains with MX records and for which a brand logo is detected. In implementations the domains may be filtered by any of the attributes/details/characteristics that are detailed or included in any of the user interfaces shown in the drawings.

The different stages discussed above do not need to always be done in the order described, but rather any possible/feasible order of operations could be accomplished. Referring to FIG. 3, any of the shown steps may be performed in any reasonably possible/feasible order. Accordingly, the recited first stage, second stage, third stage, fourth stage, etc. are meant to indicate methods that are performed by the system, but not necessarily any required order for those methods. In implementations the systems described herein may themselves initiate an automatic takedown of the malicious sites, such as automatically using website hosting APIs or automatically sending communications to the hosts or filling out online forms or the like to send to the hosts for takedown of malicious sites.

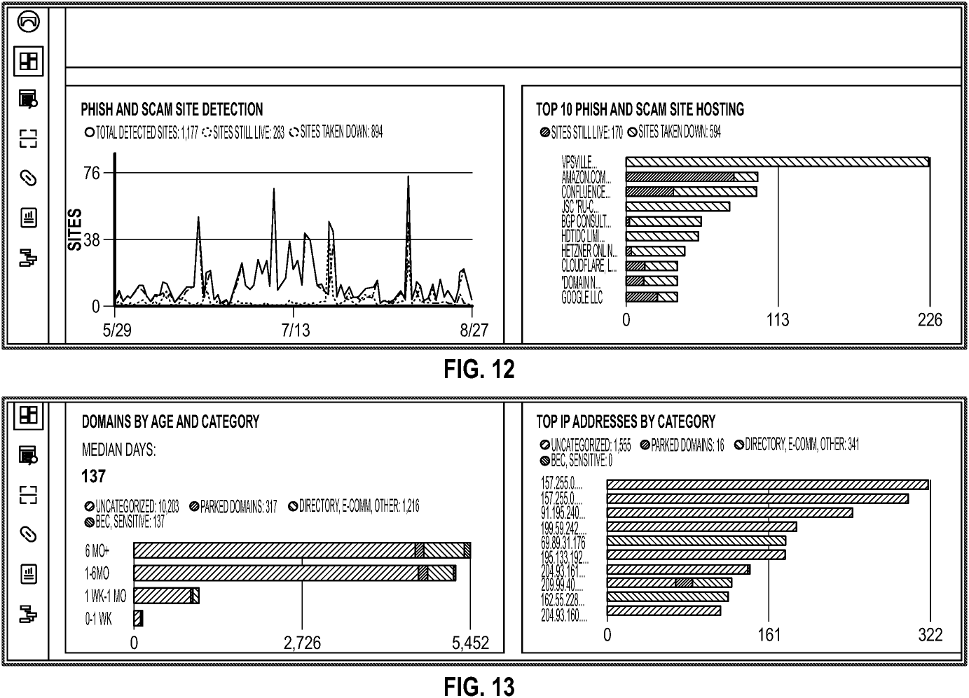

FIGS. 12-14 show other user interfaces that may be shown using the information gathered/collected by the system and/or using the determinations/categorizations made by the system. In implementations any of the user interfaces discussed herein may be consolidated (for example in practice the user interfaces of FIGS. 5 and 12-15 are implemented on a single scrollable webpage with the FIG. 5 elements at the top and the elements of FIGS. 12-15 lower down the page as the user scrolls down).

The different categories for the user interface of FIGS. 4-5 (including the main categories “Monitor for Acquisitions,” “Monitor for Pre-Malicious,” etc., and the sub-categories, may be adjusted from implementation to implementation. In some cases an administrator may adjust these and/or an end user may adjust them, as desired, to show the most relevant categories to any specific user/business. Accordingly, the specific categories and sub-categories shown herein are only representative examples. In implementations the main categories may not be changeable or may not change, but the sub-categories may be changed by the administrator or user as desired.

Referring now to FIG. 12, a graph on the left side titled “Phish And Scam Site Detection” includes—from all or some subset of the monitored domains—numbers of total detected sites, sites still live, and sites taken down on the Y-axis, and dates on the X-axis. This allows a user to quickly see a general view of overall activity related to phish and scam site detection and related action. The right side graph of FIG. 12 shows—from all or some subset of the monitored domains—a top ten list of phish and scam site hosting, breaking each bar graph down by (where applicable) sites still live and sites taken down. This allows the user to see how many phish and scam sites are hosted on each of the top ten sites (for example the top site is seen to have 226 (or nearly 226) phishing and/or scam sites taken down, with no live sites left, while other sites have a mix of some live sites and some sites that have been taken down. This interface allows the user to quickly see the top offenders, in terms of websites/hosts, and what the overall landscape looks like for such hosts. The system may include a user interface similar to FIG. 12 but which simply lists all phish and scam site hosts and allows the user to scroll down to see all site graphics. Additionally, sites other than those that are specifically phishing or scam sites may be listed—in other words other categories may be included.

Referring now to FIG. 13, the left graph titled “Domains By Age And Category” gives—from all or some subset of the monitored domains—a breakdown of domain age by number of monitored domains (which may include all monitored domains or, in some cases, only the “Monitor Pre-malicious” and “Takedown Malicious” domains). For example there are 5,452 domains that are at least six months old (either by their registration date, or their detection date, for example). Each bar graph is further parsed out to show the relative number of uncategorized domains, parked domains, directory/e-commerce/other domains, and BEC/sensitive domains. A key on the graph further gives total numbers for each of these categories, and a calculation of the median days of all domains is further given.

The right graph of FIG. 13 is titled “Top IP Addresses by Category” and lists, in descending order, the IP addresses with the most monitored domains that are either uncategorized, parked, directory/e-commerce/other, or BEC/sensitive. The bar graph for each IP address is further parsed out to visually show the relative number of uncategorized domains, parked domains, directory/e-commerce/other domains, and BEC/sensitive domains for that specific IP address. A key at the top lets the user know the color/style that represents each type of domain within the bar graphs and further gives total numbers of the different categories in all IP addresses—for instance among all the IP addresses there are 1,555 uncategorized domains, no BEC/sensitive domains, and so forth. This graph may allow the user to scroll down to see more IP addresses further down the list. One advantage of this graph is that it may allow the user to quickly and easily see which IP addresses are the most problematic for the user.

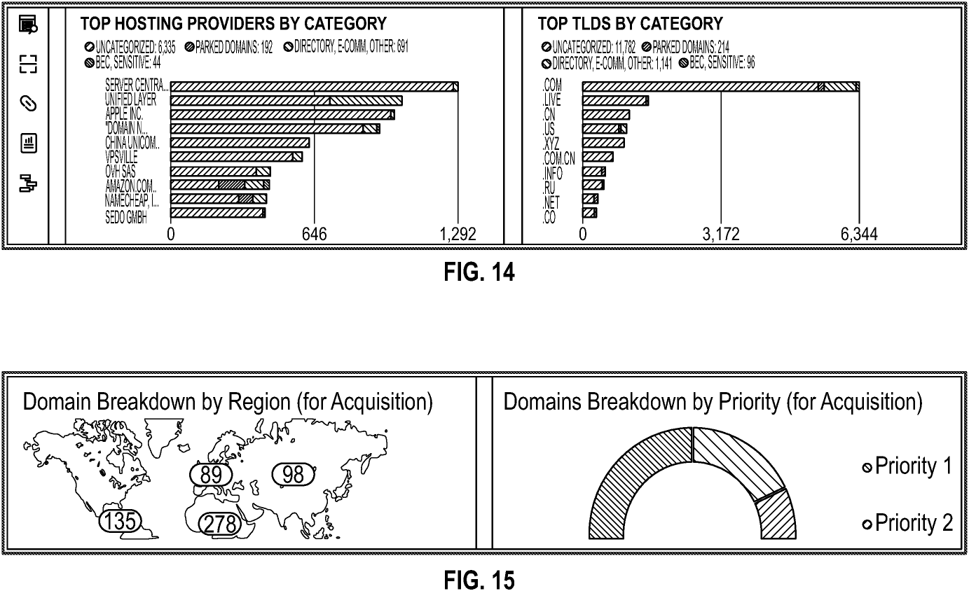

The left graph of FIG. 14 is titled “Top Hosting Providers by Category” and lists, in descending order, the hosting providers with the most monitored domains that are either uncategorized, parked, directory/e-commerce/other, or BEC/sensitive. The bar graph for each hosting provider is further parsed out to visually show the relative number of uncategorized domains, parked domains, directory/e-commerce/other domains, and BEC/sensitive domains for that specific hosting provider. A key at the top lets the user know the color/style that represents each type of domain within the bar graphs and further gives total numbers of the different categories for all hosting providers—for instance among all the hosting providers there are 6,335 uncategorized domains, 44 BEC/sensitive domains, and so forth. This graph may allow the user to scroll down to see more hosting providers further down the list. One advantage of this graph is that it may allow the user to quickly and easily see which hosting providers are the most problematic for the user.

The right graph of FIG. 14 is titled “Top TLDs by Category” and lists, in descending order, the top level domains (TLDs) with the most monitored domains that are either uncategorized, parked, directory/e-commerce/other, or BEC/sensitive. The bar graph for each TLD is further parsed out to visually show the relative number of uncategorized domains, parked domains, directory/e-commerce/other domains, and BEC/sensitive domains for that specific TLD. A key at the top lets the user know the color/style that represents each type of domain within the bar graphs and further gives total numbers of the different categories for all TLDs—for instance among all the TLDs there are 11,782 uncategorized domains, 1,141 BEC/sensitive domains, and so forth. This graph may allow the user to scroll down to see more TLDs further down the list. One advantage of this graph is that it may allow the user to quickly and easily see which TLDs are the most problematic for the user.

The left image of FIG. 15 shows a breakdown, by region, of domains recommended for acquisition. In implementations the user may click on any region or any region’s number to see further information, such as a list of the domains associated with that region that are recommended for acquisition (in any order, such as prioritized by descending acquisition priority). The region may be determined by the region associated with a TLD, a hosting provider, an IP address, and/or some other feature of a domain. This graph may quickly and easily allow a user to see which countries or regions are most problematic.

The right image of FIG. 15 shows a chart similar to a pie chart breaking down the domains recommended for acquisition into one or more priority levels. For example in the chart there are at least three priority levels shown but the user would need to scroll down the page to see the Priority 3 item in the key on the right. The priorities may allow a user to quickly see how many acquisitions are high priority (for example meriting quick or immediate acquisition), how many are medium priority (for which immediate or quick acquisition is not critical), how many are low priority (for which acquisition is not as pressing), and so forth.

Any of the user interfaces shown in the drawings may be shown on displays of computing devices shown in the system diagram of FIG. 1, and any of the user interfaces, and their functionalities, may be implemented using any of the servers, processors, and/or other elements of FIGS. 1 and/or 2.

Systems and methods disclosed herein may be used for: determining variants of a domain name including similarities in sight and/or sound and including/among several or all possible top-level domains (TLDs); determining which of the variants are registered and which are unregistered; scoring/ranking the unregistered variants to determine potential maliciousness and, based on the scoring/ranking, recommending purchase of one or more of the unregistered variants; determining the registered variants which do not yet have malicious content; scoring/ranking the registered variants to determine potential maliciousness; determining the registered variants which already have malicious content or likely malicious content, and recommending takedown; and monitoring domains which have previously been taken down.

The scoring/ranking of the unregistered variants may be based on one or more of: TLD price (or price of the actual domain name itself); a determined or input TLD maliciousness; suspicious keywords in the domain (such as determined using a list of known suspicious keywords or using an ML/AI engine); similarity with the seed domain (as determined by the fuzz algorithm and/or by an ML/AI engine); and so forth.

The scoring/ranking of the registered variants may be based on one or more of: a determined intended use associated with the registered variants (such as Parked, Directory, e-commerce, etc.); number of past phishing sites/pages hosted on the domain and/or emanating from the IP address; domain rank obtained from Stage 1; SSL certificate details; a score of the TLD itself (for example a high or low score for TLDs which are more likely to host malicious websites); deceptive domain-name practices such as coupling a known brand name with another word in a domain name; and so forth.

One or more user interfaces may visually display the variants grouped into visually separated categories such as: recommended for acquisition; monitor pre-malicious (which may be visually broken into sub-categories such as uncategorized, parked, directory, e-commerce, other, etc.); takedown malicious (which may be visually broken into sub-categories such as BEC, sensitive, etc.); monitor post-malicious; and so forth.

Any of the systems and methods disclosed herein may be at least partly implemented using one or more mobile devices—for example all of the user interfaces could be displayed, and interacted with, using one or more mobile devices, in implementations.

In implementations the systems and methods disclosed herein improve the functioning of one or more computers or computing systems by making the computers or systems more resistant to malicious attacks. For example, by automatically alerting brand owners to potential sites/domains that may be used for malicious purposes, the brand owners are enabled to purchase such sites (or initiate their takedown) and remove them from circulation. This then may reduce the overall number of malicious attacks to end users in a network, including the Internet in general. Automatically determining, using ML/AI modules/engines and the like, which web domains are most likely to host malicious content, and allowing their quick removal from circulation by purchase or takedown, makes computers and computing systems (including the Internet in general) more resistant to malicious attacks by systematically removing likely avenues of attack. This improves the overall functioning of the computers and systems—for instance decreasing overall down time and damage from successful attacks.

It is also pointed out that training a machine learning module, or the like, as discussed herein, inherently improves the functioning of a computer or system because it improves the computer’s or system’s ability to correctly identify malicious web domains so that the user may take action by removing web domains through purchase or takedown or the like.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of systems and methods for categorizing and visualizing web domain lifecycles, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element— if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

As used herein, the term “of” may refer to “coupled with.” For example, in some cases displays are referred to as a display “of” a first computer or computing device, a display “of” a second computer or computing device, and so forth. These terms are meant to be interpreted broadly so that a display “of” a computing device may be a separate display that is, either by wired or a wireless connection, communicatively coupled with the computing device.

The phrase “computing device” as used herein is meant to include any type of device having one or more processors and capable of communicating information using one or more integrated or communicatively-coupled displays, such as a personal computer, a laptop, a tablet, a mobile phone, a smart phone, a personal data assistant (PDA), smart glasses, a tablet, a smart watch, a smart speaker, a robot, any other human interaction device, and so forth.

It is pointed out that the provider of a software application, to be installed on end user computing devices (such as, by non-limiting example, mobile devices) at least partially facilitates an at least intermittent communicative coupling between one or more servers (which host or otherwise facilitate features of the software application) and the end user computing devices. This is so even if the one or more servers are owned and/or operated by a party other than the provider of the software application.

Method steps disclosed anywhere herein, including in the claims, may be performed in any feasible/possible order. Recitation of method steps in any given order in the claims or elsewhere does not imply that the steps must be performed in that order (unless it is explicitly stated that they are required to be performed in that order)—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A system for categorizing and visualizing web domain details, comprising:
one or more processors configured to automatically determine a plurality of domain variants, using a provided seed domain, based on a level of similarity with the seed domain, the one or more processors further configured to categorize the domain variants into a plurality of categories; and
one or more servers communicatively coupled with one or more computing devices and configured to provide one or more user interfaces for display on the one or more computing devices, the one or more user interfaces comprising:
a visual display of the categories; and
for each of the categories, an indicator indicating a total number of the domain variants within that category.

2. The system of claim 1, wherein the domain variants are associated with a plurality of top-level domains (TLDs).

3. The system of claim 1, wherein the one or more processors are configured to determine a registration status for each of the domain variants, and wherein the one or more user interfaces includes a visual display of the registration status of at least some of the domain variants.

4. The system of claim 1, wherein the one or more processors are configured to determine, for each of the domain variants, a score related to a potential maliciousness of the domain variant.

5. The system of claim 4 wherein, if the domain variant is registered, the score is based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; and a determination of likely deception related to a known brand name.

6. The system of claim 4 wherein, if the domain variant is unregistered, the score is based on one or more of: an average domain registration price associated with a top-level domain (TLD); a price for registration of the domain variant; a determined TLD maliciousness; one or more terms in the domain variant determined to be suspicious; and the level of similarity with the seed domain.

7. The system of claim 4, wherein the one or more processors are configured to, based on the score, determine whether the domain variant should be recommended for acquisition and, if so, initiate display of an acquisition recommendation on the one or more user interfaces.

8. The system of claim 1, wherein the one or more processors are further configured to determine, for each of the domain variants which is registered, whether a website associated with the domain variant includes malicious content.

9. The system of claim 8, wherein the one or more processors are further configured to, in response to determining that the website includes malicious content, initiate display of a takedown recommendation on the one or more user interfaces.

10. The system of claim 9, wherein the one or more processors are further configured to monitor content of the website after a takedown and, in response to determining that the website again includes malicious content, initiate display of another takedown recommendation on the one or more user interfaces.

11. The system of claim 1, wherein the categories include at least: a category for unregistered domains recommended for acquisition; a category for registered domains recommended for monitoring; and a category for registered domains recommended for takedown.

12. The system of claim 11, wherein the category for registered domains recommended for monitoring comprises a plurality of subcategories, including at least one subcategory for parked domains.

13. The system of claim 1, wherein the visual display of the categories includes, for each category, a displayed container.

14. A method for categorizing and visualizing web domain details, comprising:
using one or more processors:
determining a plurality of domain variants, using a provided seed domain, based on a level of similarity with the seed domain;
determining a registration status for each of the domain variants;
categorizing the domain variants into a plurality of categories; and
using one or more servers communicatively coupled with one or more computing devices, providing one or more user interfaces for display on the one or more computing devices, the one or more user interfaces comprising:
a visual display of the categories;
a visual display of the registration status of at least some of the domain variants; and
for each of the categories, an indicator indicating a total number of the domain variants within that category.

15. The method of claim 14 further comprising, using the one or more processors, determining, for each of the domain variants, a score related to a potential maliciousness of the domain variant, wherein the score is based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; a determination of likely deception related to a known brand name; an average domain registration price associated with a top-level domain (TLD); a price for registration of the domain variant; a determined TLD maliciousness; one or more terms in the domain variant determined to be suspicious; and the level of similarity with the seed domain.

16. The method of claim 14, wherein the categories include at least: a category for unregistered domains recommended for acquisition; a category for registered domains recommended for monitoring; and a category for registered domains recommended for takedown.

17. The method of claim 14 further comprising, using the one or more processors, determining, for each of the domain variants which is registered, whether a website associated with the domain variant includes malicious content and, in response to determining that the website includes malicious content, initiating display of a takedown recommendation on the one or more user interfaces.

18. A system for categorizing and visualizing web domain details, comprising:
one or more processors;
one or more non-transitory computer-readable media storing instructions executable by the one or more processors, wherein the instructions, when executed, cause the system to train one or more machine learning (ML) modules to:
automatically determine a plurality of domain variants, using a provided seed domain, based on a level of similarity with the seed domain; and
categorize the domain variants into a plurality of categories, wherein the categories include at least: a category for unregistered domains recommended for acquisition; a category for registered domains recommended for monitoring; and a category for registered domains recommended for takedown; and
one or more servers communicatively coupled with one or more computing devices and configured to provide one or more user interfaces for display on the one or more computing devices, the one or more user interfaces comprising:
a visual display of the categories; and
for each of the categories, an indicator indicating a total number of the domain variants within that category.

19. The system of claim 18 wherein the instructions, when executed, cause the system to train the one or more ML modules to determine, for each of the domain variants, a score related to a potential maliciousness of the domain variant, wherein the score is based on one or more of: a determined intended use for the domain variant; a number of malicious sites previously accessible using the domain variant; a number of malicious pages previously accessible using the domain variant; a number of malicious sites previously hosted on an internet protocol (IP) address of the domain variant; a number of malicious pages previously hosted on the IP address of the domain variant; Security Sockets Layer (SSL) certificate details associated with the domain variant; a determined score for a top-level domain (TLD) of the domain variant; a determination of likely deception related to a known brand name; an average domain registration price associated with a top-level domain (TLD); a price for registration of the domain variant; a determined TLD maliciousness; one or more terms in the domain variant determined to be suspicious; and the level of similarity with the seed domain.

20. The system of claim 18 wherein the instructions, when executed, cause the system to train the one or more ML modules to determine, for each of the domain variants which is registered, whether a website associated with the domain variant includes malicious content.
